(19) United States
(12) Patent Application Publication
(10) Pub. No.: US 2024/0065817 A1
(43) Pub. Date: Feb. 29, 2024

(54) SYSTEM FOR IMPROVED CLEANING OF TEETH

(71) Applicant: Stephen Ruffa, Oak Hill, VA (US)

(72) Inventor: Stephen Ruffa, Oak Hill, VA (US)

(21) Appl. No.: 18/241,947

(22) Filed: Sep. 4, 2023

Related U.S. Application Data
(63) Continuation-in-part of application No. 17/894,342, filed on Aug. 24, 2022, now abandoned.

(51) Int. Cl. A61C 15/04

(52) U.S. Cl. CPC A61C 15/043; A61C 15/041

(57) ABSTRACT

A dental hygiene device for cleaning surfaces between adjacent teeth is disclosed. The dental hygiene device includes a housing configured to be held by a hand during flossing; where the housing includes a chamber within the housing; a toothpaste dentifrice solution contained within the chamber; and dental floss disposed within the housing on a spool, the dental floss and the spool configured to thread through the chamber, where the chamber comprises one or more apertures configured to allow the dental floss to receive a thin coat of the toothpaste dentifrice solution while passing through the chamber, where the chamber comprises a floss directing implement to improve adhesion of the toothpaste dentifrice onto the surface of the floss as it passes through the chamber.

### CROSS-REFERENCE TO RELATED APPLICATIONS

This continuation-in part application claims priority to U.S. application Ser. No. 17/894,342, titled “System For Improved Cleaning Of Teeth”, filed Aug. 24, 2022, the entirety of which is incorporated here by reference.

### BACKGROUND

### Technical Field

This disclosure relates to dental hygiene. In particular, the disclosure relates to an improved system for cleaning teeth surfaces.

Dental hygiene tools are known in the art.

U.S. Pat. No. 5,076,302 describes an apparatus for and method of dispensing dental floss.

U.S. Pat. No. 7,071,591 describes particulate coated monofilament devices.

U.S. Pat. No. 8,381,743 describes a combined toothpaste container cap dental floss.

WO 2009/132474 describes dental floss coated with powder.

WO 2011/089282 describes a screw cap with dental floss deposit.

Examples of conventional art describe device with a chamber containing a floss spool, a second chamber containing a dentifrice solution, and apertures between the chamber and exiting the device through which the floss progresses. The dentifrice solution can be a liquid, powder, or a gel. Others describe devices that include an adaptor or inlet to receive a toothpaste tube wherein the coating of the floss occurs when the toothpaste tube is squeezed “as the floss passes through the openings in the main body of the device.”

Other conventional art includes a dental floss dispenser that impregnates floss with a fluoride liquid solution. The container includes a hinge which reveals the inside of the device.

Yet another describes dental floss dispenser having a wicking delivery system with a reservoir for storing a solution of oral care ingredients primarily in fluid form. The reservoir includes an absorbent wicking porous pad that extends through at least a portion of the floss dispensing device to deliver the solution to the dental floss. When the floss is pulled through the porous pad holding the liquid, it is absorbed by the floss. This device has an exit aperture of up to 3 times the floss diameter, so the liquid is not squeezed off

Good oral hygiene contributes to a person's overall health. It is widely understood that brushing teeth twice a day is important for good oral hygiene, as well as for maintaining an attractive smile and preventing bad breath. Cleaning between teeth is crucial as well. But cleaning between teeth is typically limited to flossing, which misses a key element that has been widely accepted as a standard part of effective brushing.

Brushing teeth typically consists of a two-part solution: direct mechanical-type cleaning from the toothbrush, combined with a mild abrasive from the toothpaste that is squeezed onto the toothbrush. The pairing of mechanical action with the mild abrasive is widely considered necessary for breaking up biofilm buildup on the tooth surfaces, a primary outcome that brushing is intended to achieve.

Brushing, however, only reaches approximately 60 percent of teeth's surfaces, leaving the surfaces between the teeth to be cleaned by flossing. Since there is no ready means for applying toothpaste to the floss as is done with a toothbrush, approximately 40 percent of the teeth's surfaces cannot be reached using the widely accepted method of pairing brushing with the mild abrasive accompaniment of toothpaste.

The disclosed device provides the means for cleaning the surfaces between the teeth similarly to brushing. It deposits a thin coating of toothpaste onto the surface of the floss by drawing it though a chamber filled with toothpaste, and then regulates the coating to deposit the needed abrasive ingredients, but sufficiently thin as to give the dental floss a moist but non-slippery feel which testing has shown does not interfere with flossing. Coating

toothpaste on the floss also serves to lubricate the floss, permitting it to better glide into tight spaces. Finally, the floss delivers active ingredients from the toothpaste, particularly fluoride, to these surfaces that cannot be reached by brushing.

This disclosed device is unique in that no prior art is specifically designed to apply toothpaste to the surface of dental floss by drawing the floss through a chamber containing this dentifrice material and then regulating its coating to the needed surface thickness as it is drawn from the device. This disclosure identifies key features that solve the

specific problems which were not identified by any prior art:

Adhering Dentifrice to the Floss: Prior art that disclose a similar configuration are primarily designed for use with dental solutions in liquid form, applied primarily by means of absorption into the dental floss. No prior art addresses the unique challenge of causing a toothpaste-type dentifrice to adhere to the surface of the floss by drawing the floss

through a chamber of this semi-solid material. A key problem is that a rut is naturally created as the floss is drawn through a toothpaste dentifrice (something that does not occur with a liquid or powder), which causes the floss that that is subsequently drawn through the dentifrice to no longer be in contact thus preventing further adherence. This disclosure solves this problem using design details including chamber shapes, non-stick chamber materials,
inserts, aperture shapes, floss spooling configurations, and configurations developed through testing that can overcome this problem. Prior art does not include these and will not work for applying toothpaste dentifrice to dental floss without them.

Regulating the Coating Thickness: The optimal dentifrice coating is thick enough to deposit the needed abrasive ingredients, but sufficiently thin as to give the dental

floss a moist but non-slippery feel which testing has shown does not interfere with flossing. The disclosed device produces this coating by regulating the final thickness of toothpaste dentifrice that can exit the device on the floss by dimensioning an exit aperture to a diameter that will remove dentifrice in excess of this thickness as the dental floss is pulled through it. Prior art instead cannot work in this manner, because it either identifies the exit aperture to be
liquid-tight which would scrape off the toothpaste dentifrice coating, or of a sufficiently larger diameter than the floss diameter so that it that doesn't interact at all with the coated floss. For example, US 2013/0316070 A1 identifies that the diameter can be as much as three times the floss diameter because it first adequately impregnates the dental floss with a dentifrice using pads that rely on wicking-defined as absorption of liquid by capillary
action—that specifically can only work with a liquid and cannot work for a non-liquid, toothpaste dentifrice. No prior art identifies the need for configuring the aperture dimension specifically to interact with a toothpaste dentifrice in order to regulate the coating thickness, which testing has shown is necessary to produce the combination of needed abrasive ingredients and surface characteristics that do not interfere with flossing.

Operating Seamlessly during Flossing: The disclosed device is designed to permit the user to comfortably hold the device during flossing and draw coated floss from the

container while flossing. This fundamentally differs from prior art which identifies a size which might only incidentally suffice to be held by hand but is not designed to seamlessly withdraw floss coated with toothpaste dentifrice during flossing, nor does it contain the internal configuration, including the dentifrice chamber shape, materials, and/or inserts, along with the configuration of the exit aperture and openings between chambers, allowing it to
automatically coat floss with a toothpaste-like dentifrice of an optimal thickness as it is drawn from the device while flossing. The external size and shape of the disclosed device, in conjunction with the internal aspects, work together to make it possible to hold the device while dispensing floss with the needed coating of toothpaste dentifrice during flossing. A second configuration is intended to be attached to a toothpaste tube and permits the user to
withdraw a length of coated floss and clip it off for use prior to flossing. The disclosed device is fundamentally different from all prior art in that it is designed to automatically coat the floss with a toothpaste-like substance as it is drawn through toothpaste dentifrice contained in the device and includes an exit aperture that regulates the dentifrice thickness on the floss surface to deposit the needed abrasive ingredients while producing a surface that is
sufficiently thin to form a non-slippery consistency when it is drawn from the device.

Although conventional art describes a device that uses a toothpaste-type dentifrice, it does not apply the dentifrice in the same manner and will not work to perform the necessary functions. Instead of coating the floss by drawing it through an unpressurized dentifrice chamber as the disclosed device does, conventional art coat the floss using direct

pressure imparted by squeezing an attached toothpaste tube positioned directly over the floss. This cannot meet the need to operate seamlessly during flossing, since the user would have to concurrently hold the device while squeezing the tube, while also withdrawing the floss. Moreover, conventional art identifies that the hole through which the floss travels from the spool chamber must be tight fitting to prevent pressurized dentifrice from migrating into the
chamber containing the floss spool, which cannot work with design details that cause adhesion of toothpaste dentifrice to the dental floss in the disclosed device. Conventional art does not describe any role of the exit aperture in coating the floss, which is critical to the
operation of the disclosed device. Therefore, the concept and structure described by conventional does not address key elements of this design, are fundamentally different and therefore not relevant, and cannot be made to work to produce the same results.

Therefore, a need exists for a dental solution for providing a similar degree of cleaning as tooth brushing for the surfaces between teeth.

### COPYRIGHT NOTICE

A portion of the disclosure of this patent document contains material, which is subject to copyright protection. The copyright owner has no objection to the facsimile

reproduction by anyone of the patent document or the patent disclosure, as it appears in the Patent and Trademark Office patent files or records, but otherwise reserves all copyright rights whatsoever.

### SUMMARY

A dental hygiene device for cleaning surfaces between adjacent teeth is

disclosed. The dental hygiene device includes: a housing configured to be held by a hand during flossing, where the housing includes a chamber within the housing; a toothpaste dentifrice solution contained within the chamber; and dental floss disposed within the housing on a spool, the dental floss and the spool configured to thread through the chamber, where the chamber comprises one or more apertures configured to allow the dental floss to
receive a thin coat of the toothpaste dentifrice solution while passing through the chamber, where the chamber comprises a floss directing implement to improve adhesion of the toothpaste dentifrice onto the surface of the floss as it passes through the chamber, the dental floss further configured to exit the chamber through an inner exit aperture of the one or more apertures in the housing, sufficient to permit the dental floss to pass through with a thin coat
of the toothpaste dentifrice solution on the external surface of the dental floss, the inner exit aperture configured to extend out of the housing through an outer exit aperture, where a diameter of the inner exit aperture is sized with a sufficiently greater diameter than a diameter of the dental floss to regulate the amount of dentifrice that passes through the aperture on the floss to allow sufficient abrasive ingredient to coat the floss, but no larger than is needed to
allow enough dentifrice to pass through to produce a moist but non-slippery surface on the
floss, and where the housing size and shape are specifically configured to permit the device to be comfortably held while also drawing floss coated with dentifrice from the device while flossing.

Other systems, methods, features and advantages of the invention will be, or

will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a view of a first aspect of a dental hygiene device according to the disclosure.

FIG. 2 is a view of a second aspect of a dental hygiene device according to the disclosure.

FIG. 3 is a view of a third aspect of a dental hygiene device according to the disclosure.

FIG. 4 is a view of a fourth aspect of a dental hygiene device according to the disclosure.

FIG. 5 is a view of a fifth aspect of a dental hygiene device according to the disclosure.

FIG. 6 is a view of a sixth aspect of a dental hygiene device according to the disclosure.

FIG. 7 is a view of a seventh aspect of a dental hygiene device according to the disclosure.

FIG. 8 is a view of an eighth aspect of a dental hygiene device according to the disclosure.

FIG. 9A-9C is a view of a ninth aspect of a dental hygiene device according to the disclosure. FIG. 9A provide a view of the claimed invention where the peg 908 is in a far-left position. FIG. 9B provide a view of the claimed invention where the peg 908 is in the bottom position. FIG. 9C provide a view of the claimed invention where the peg 908 is in a far-right position.

FIG. 10 is a view of a tenth aspect of a dental hygiene device according to the disclosure.

### DETAILED DESCRIPTION

In view of the known types of apparatus and methods present in the prior art, this invention provides a new and improved dental floss dispenser which specifically addresses the need to pair the mechanical cleaning action that comes from flossing with the

mild abrasive action from toothpaste to provide a cleaning method for the surfaces between the teeth, producing a similar result to the approach that has been widely accepted for brushing the other teeth surfaces.

As such, the general purpose of this invention is to deposit a thin coating of toothpaste onto the surface of the floss which contains a mild abrasive, similar to applying

toothpaste to a toothbrush as is typical when brushing teeth. The toothpaste on the floss also serves to lubricate the floss, permitting the floss to better glide into tight spaces. Finally, the coated floss also delivers active ingredients contained within the toothpaste, particularly fluoride, to these surfaces that cannot be reached by brushing.

The disclosed device works by automatically depositing a thin coating of toothpaste onto the surface of the floss by drawing it though a toothpaste dentifrice, with its exit aperture dimensioned for regulating the thickness on the floss as it is drawn from the device, giving the floss a sufficiently thin film to not interfere with flossing but thick enough to deposit the needed abrasive ingredients on the floss. Its general configuration includes: a dispensing device designed to be held by a hand, a first chamber containing dental floss

positioned around a spool, the first chamber positioned within the dispensing device, where the first chamber comprises a first outlet opening through which dental floss exits the first chamber, a second chamber containing a toothpaste dentifrice solution, the second chamber positioned proximate to the first chamber, where the second chamber is positioned within the dispensing device, and the second chamber includes an inlet opening positioned on a first
surface of the second chamber and proximate to and in mechanical communication with the outlet opening of the first chamber, where the dental floss that exits the first chamber enters the inlet opening of the second chamber and an outlet aperture positioned on a second surface
of the second chamber, where the dental floss exits the outlet aperture and out of the dispensing device, which is dimensioned to regulate the coating thickness on the dental floss. The second chamber may be shaped to improve dentifrice adhesion and contain non-stick materials and/or mechanical floss directing elements such as pins or baffles or inserts such as
a membrane or bladder through which the floss may be positioned within the second, dentifrice, chamber. The spool within the first chamber around which the dental floss is positioned may be configured in a way that is non-circular, such as positioned on an asymmetric cam, causing the positioning of the dental floss as it is drawn from the spool to vary, thus constantly changing the path that the dental floss moves as it exits the chamber,
through the inlet opening into the second chamber, and through the second chamber, causing the dental floss to sweep across the second chamber which can provide improved contact with toothpaste dentifrice solution within the second chamber. Other features and implements may produce this result while minimizing dimensional requirements and thus supporting the device sizing constraints for a handheld configuration.

Making this device work required innovations in three areas, which were only identified from producing and testing alternate configurations, and are disclosed:

First, this device solves the problem of causing a toothpaste-like dentifrice to evenly adhere to floss as it is drawn through the dentifrice chamber. As the floss advances through the dentifrice chamber, its tendency is to erode a rut through the dentifrice, forming a

gap between the dentifrice and the dental floss which can reduce contact with the dental floss and may cause a reduced adherence of the dentifrice to the floss. This device includes features that address this problem so that the floss may remain in close proximity with the toothpaste and continue to adhere even as the toothpaste dentifrice is depleted. These details work in conjunction with the aperture that is sized to limit the amount of dentifrice that is
drawn from the chamber, both regulating the finished surface on the dental floss and causing dentifrice to accumulate inside of the aperture as excess is scraped from the dental floss which promotes greater contact with the floss and thus improved adhesion. The chamber can be lined with a non-stick material (such as Teflon), which reduces the adhesion to the chamber walls, and the chamber can be narrowed so that its walls remain in closer proximity
to the floss thereby creating greater affinity for the dentifrice to adhere to the floss than to adhere to the chamber walls, reducing the potential for dentifrice to separate or cause a rut rather than adhere to the floss. Testing has demonstrated a reduced potential to create a rut
when the distance of the floss from Teflon lined chamber walls is reduced to approximately a quarter of an inch. Alternatively, the spool within the first chamber around which the dental floss is positioned may be configured in a way that is non-circular, with a shape causing a substantial change to the positioning of the dental floss from the center of the spool as it is
drawn from the spool, thus constantly changing the path that the dental floss moves as it exits the chamber, through the inlet opening into the second chamber, and through the second chamber, causing the dental floss to sweep across the second chamber which can provide improved contact with toothpaste dentifrice solution within the second chamber. Another approach is mounting the floss spool on a non-circular cam of a shape that causes substantial
change in the positioning of the dental floss as it is drawn over the cam, thus changing the path that the dental floss progresses as it departs the cam, exits the chamber, progresses through the inlet opening into the second chamber, and through the second chamber, causing the dental floss to sweep across the second chamber which can provide improved contact with toothpaste dentifrice solution within the second chamber. The inlet opening through
which floss exits the first chamber and enters the second chamber can be slotted or otherwise shaped, allowing the angle of the floss to change, thereby causing the floss sweep across the chamber, changing the location of the floss within the chamber rather than reducing the size of the chamber, reducing the tendency to create a rut in the dentifrice. Baffles, pegs, or other mechanical means, such as adding implements for directing the floss back and forth as it exits
the floss chamber, may also be used to alter the pathway of the floss and to cause accumulation of dentifrice in the path of the floss, thereby improving adhesion. Alternative configurations of the second chamber to improve the adhesion of toothpaste dentifrice on the floss include but are not limited to passing the floss through a bladder or membrane containing the dentifrice that collapses as dentifrice is consumed, causing the dentifrice to
draw towards the floss as it is diminished, thus maintaining dentifrice in close proximity to the floss to promote adhesion. No prior art identifies this issue or identifies these or any configurations that overcome the problems of making toothpaste adhere to the floss as the floss is drawn through the toothpaste dentifrice.

Second, this device interacts with the dentifrice to form a coating on the floss that does not interfere with the act of flossing. A coating of toothpaste dentifrice on the floss that is too thick will produce a slippery, messy surface that makes it difficult to hold and use the dental floss as intended, thereby interfering with the act of flossing. The disclosed device instead produces a surface, identified from testing, that is non-slippery but thick enough to deposit the needed abrasive ingredients. The disclosed device actively regulates this thickness using the aperture through which the floss exits the device, which is dimensioned to permit the floss to pass through while coated with a dentifrice thickness that is sufficient to deposit

sufficient abrasive particles but no greater, to produce this surface on the floss. The aperture diameter is slightly larger than the diameter of the floss, with a sufficiently large diameter to produce a minimal but sufficiently thick film of toothpaste on the floss surface to allow a continuous distribution of suspended abrasive particles to pass through the aperture as floss is drawn from the device. One example demonstrated during testing is of an aperture
dimensioned to approximately 1.2 times the diameter of the dental floss. No prior art identifies this issue or identifies these or any configurations that overcome the problems of regulating the coating to produce the needed finish using this semi-solid dentifrice substance on floss.

Third, this device operates in a manner that is simple, intuitive, and seamless

so as to not complicate the act of flossing. This disclosure includes two configurations, each designed specifically to meet this need. The first is a handheld configuration that permits the user to comfortably hold the device and seamlessly draw coated floss from the container while flossing. This fundamentally differs from prior art which identifies a dispenser that is only incidentally of a size that can be held by hand, whereas this disclosure combines an
external size and shape specifically designed for this purpose. The combination of its external size and shape with its automatic coating of toothpaste dentifrice on the floss as it is drawn from the device during flossing, work together to allow its simple, seamless use during flossing. Making this possible are configuration details, identified by trial and error, including external size and shape, the dentifrice chamber shape, materials, inserts, mechanical features,
and the configuration of the exit aperture. One example demonstrated during testing is of an external housing dimension of approximately 2½ inches in height and 1¾ inches in width, with the exterior curved on one side. A second configuration is intended to be attached to a toothpaste tube and permits the user to withdraw a length of coated floss prior to flossing and use it just as is typically done during flossing. Squeezing the toothpaste tube does not directly
apply toothpaste to the floss, as it does with other conventional art, but serves as a means for refilling the dentifrice chamber. Like the first configuration, the dentifrice adheres to the floss within the disclosed device as it is drawn through the chamber, with the exit aperture
dimensioned to actively regulate the final dentifrice coating thickness on the floss. Making this possible are the same internal configuration and details, including the configuration of the exit aperture. Other attempts in the conventional art are fundamentally different in that they do not contain this configuration or necessary details, and therefore it is irrelevant, and
no part of its design could inform the invention of this device.

The dental hygiene device may provide multiple means for replenishing toothpaste in the chamber, including directly attaching the dispenser to a toothpaste tube, and a disposable version in which sufficient toothpaste to coat a single spool of floss is contained in the unit. A reusable version is included as well, consisting of a clamshell construction,

hinged on one side and snapping closed on the other, which opens the chamber and exposes the spool, making replacing both the floss and refilling the chamber with toothpaste quick and simple.

The dental hygiene device provides three capabilities that are essential for a practical solution. First, it provides a simple, repeatable means for applying a thin coating of

toothpaste (or another substance with similar properties and abrasion action) on dental floss as it is used. It does this by drawing the floss through the dentifrice, and then regulating its thickness for a thin, non-slippery film that provides sufficient abrasive materials but without interfering with the act of flossing. Second, it is configured to operate in a manner that is simple, intuitive, and seamless so as to not complicate the act of flossing. This includes two
basic configurations: handheld, which is specifically designed to be held and the floss extracted while flossing; and a configuration that is attached as an extension to the tube that allows for length of coated floss to be extracted prior to flossing (and toothpaste to be dispensed onto a brush through a separate nozzle). Third, these dispensing device configurations may include both reusable and disposable versions, all using the same basic
concept and design features for coating the dental floss for a surface that does not interfere with flossing, and configured to operate in a manner that is simple, intuitive, and seamless. Reusable versions include a capability to recharge the dentifrice and/or floss spool using multiple concepts and configurations.

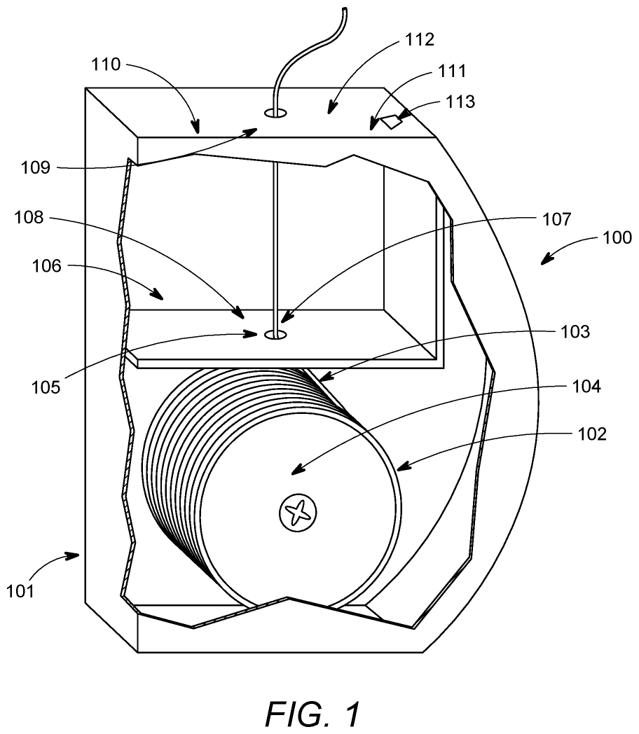

FIG. 1 illustrates a view of an aspect of the basic configuration of the disclosed dental hygiene device 100. The dental hygiene device 100 includes a dispensing device 101 configured to be held by a user's hand. A first chamber 102 may contain dental floss 103 positioned around a spool 104, the first chamber 102 positioned within the dispensing device

101, where the first chamber 102 comprises a first outlet hole 105 through which dental floss 103 exits the first chamber 102. A second chamber 106 may contain a dentifrice solution, the second chamber 106 positioned proximate to the first chamber 102, where the second chamber 106 is positioned within the dispensing device 101, and the second chamber 106
further includes an inlet hole 107 positioned on a first surface 108 of the second chamber 106 and proximate to and in mechanical communication with the outlet hole 105 of the first chamber 102. The dental floss 103 may exit the first chamber 102 and enter the inlet hole 107 of the second chamber 106. A second outlet hole 109 is positioned on a second surface 110 of the second chamber 106, where the dental floss 103 may exit the second outlet hole 109 and
out of the dispensing device 101. The dental hygiene device 100 may include a hand-held dispenser designed to be grasped by a user during flossing. The dental hygiene device 100 may be configured to fit comfortably into the user's hand, allowing the dental floss 103 to be extracted by the user through the second outlet hole 109 located between a thumb and index finger of the user, which may be a location that makes it easy to hold the dental hygiene
device 100 while grasping the floss 103 during flossing. Pulling the floss 103 from the dispensing device 101 as it is needed during flossing minimizes the amount of toothpaste that rubs off during use. In another aspect of the disclosure, the dental hygiene device 100 may include, positioned on the dispensing device 101, a tab 111 positioned on a surface 112 of the dispensing device 101, where the tab 111 is angled outwardly relative to the surface 112 of
the dispensing device 101, and the tab 111 may include a clipper edge 113 configured to accept the dental floss 103 and sever the dental floss 103. When flossing is complete the floss 103 may be cut off on the clipper edge 113.

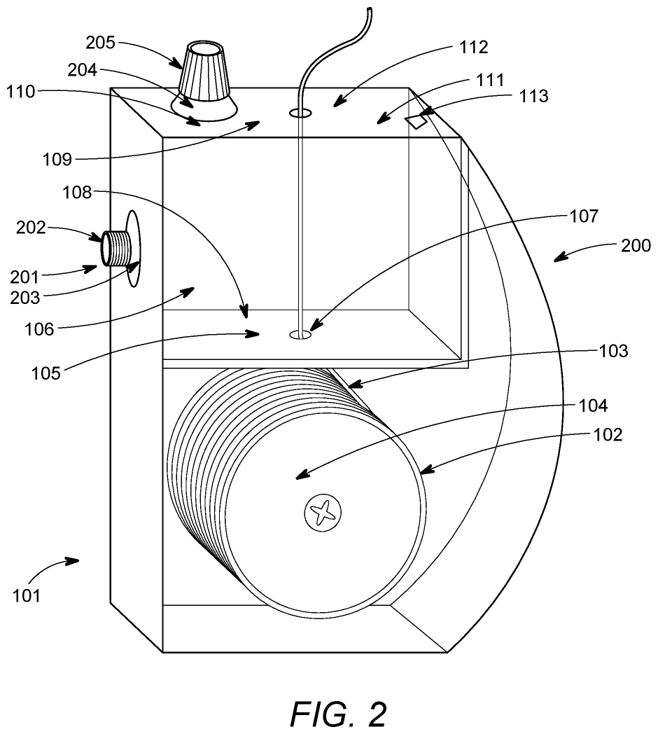

FIG. 2 is a view of a second aspect of a dental hygiene device 200 according to the disclosure. The dental hygiene device 200 may include a dispenser adaptor 201. The

dispenser adaptor 201 may be adaptively coupled to the dispensing device 101 and may allow attachment of the dispensing device 101 to a toothpaste tube (not shown) and is intended for coating the desired length of floss 103 prior to each usage, clipping it off with the clipper edge 113. The toothpaste tube may be screwed into the dispensing device 101 via the dispenser adaptor 201, attached at 202 to nozzle 203. The toothpaste tube automatically fills
the second chamber 106 within the device each time toothpaste is squeezed for use. An outlet nozzle 204 may be disposed on the outer surface 110 of the dental hygiene device 200, configured as an alternate means for dispensing toothpaste from the chamber 106 through
nozzle 204 during brushing and flossing when the toothpaste container (not shown) is squeezed. The outlet nozzle 204 may include a cap 205 disposed upon the outlet nozzle 205 to prevent leakage of toothpaste.

The dental hygiene devices 100 and 200 may include a range of design

features to enhance coating of the floss 103. The dental hygiene devices 100 and 200 may include non-stick coatings, bladders, or membranes to enhance coating of the floss 103. The dental hygiene devices 100 and 200 may include floss directing implements such as pegs or rollers and implements to direct the floss 103 within the dispensing device 101 as it moves through the dispensing device 101.

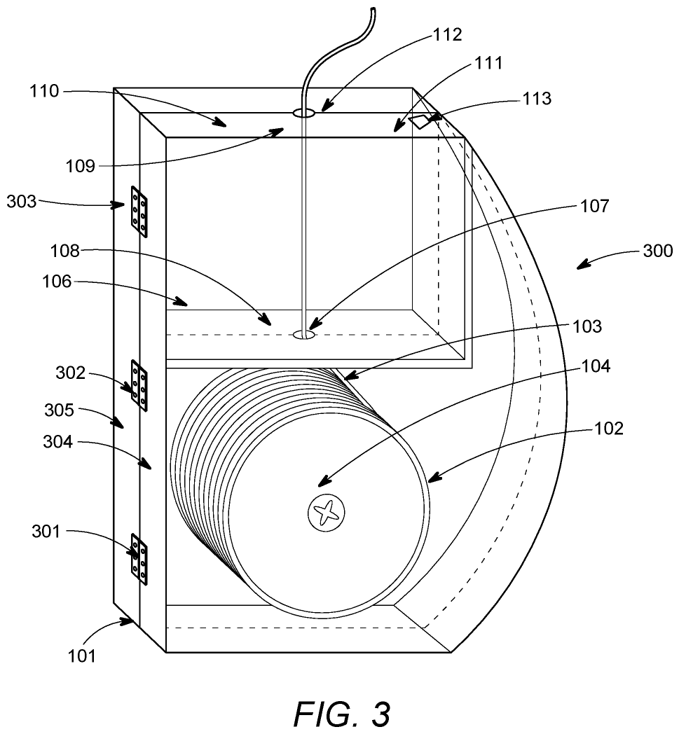

FIG. 3 is a view of a third aspect of a dental hygiene device 300 according to the disclosure. The dental hygiene device 300 may be configured as a reusable system. The dental hygiene device 300 may include a first hinge 301, a second hinge 302 and a third hinge 303, each adaptively coupled with and disposed on the dispensing device 101. The first hinge 301, the second hinge 302 and the third hinge 303 may allow the dental hygiene device 300

to be configured as a clamshell construction, hinged so that a first hinged surface 304 may move relative to a second hinged surface 305 and along the axis of the first hinge 301, the second hinge 302 and the third hinge 303 so that the dental hygiene device 300 may be snapped closed. These hinges may be replaced with other methods for opening and attaching the first surface 304 and the second surface 305.

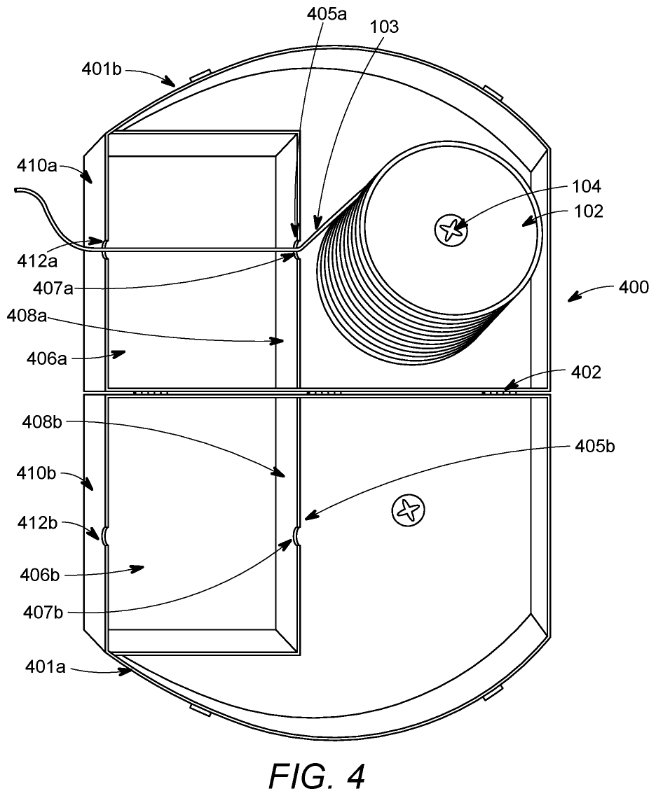

FIG. 4 is a view of fourth aspect of a dental hygiene device 400 according to the disclosure. In this aspect of the disclosure, a clamshell open-view of the dental hygiene device 400 is displayed. The dental hygiene device 400 may include a first open surface 401a and an opposing second open surface 401b. When the first open surface 401a is moved about a hinge 402, the first open surface 401a meets congruently with the second open surface 401b

to form a fully closed dental hygiene device 400, similar to the dental hygiene device 300 depicted in FIG. 3.

In an aspect of the disclosure, the dental hygiene device 400 may include corresponding parts on either side of the hinge 402 that join together when the dental hygiene device is closed. The dental hygiene device 400 may thus include a first inner chamber outlet

405a and a second inner chamber outlet 405b that match each other when joined via movement about the hinge 402. The dental hygiene device 400 may thus include a first upper chamber inlet 407a disposed upon a surface 408a of a first upper chamber 406a and a second
upper chamber inlet 407b disposed upon a second surface 408b of second upper chamber 406b that match each other when joined via movement about the hinge 402. The dental hygiene device 400 may include a first upper chamber outlet 412a disposed upon a first outer surface 410a of a first upper chamber 406a and a second upper chamber outlet 412b disposed
upon a second outer surface 410b of the second upper chamber 406b that match each other when joined via movement about the hinge 402.

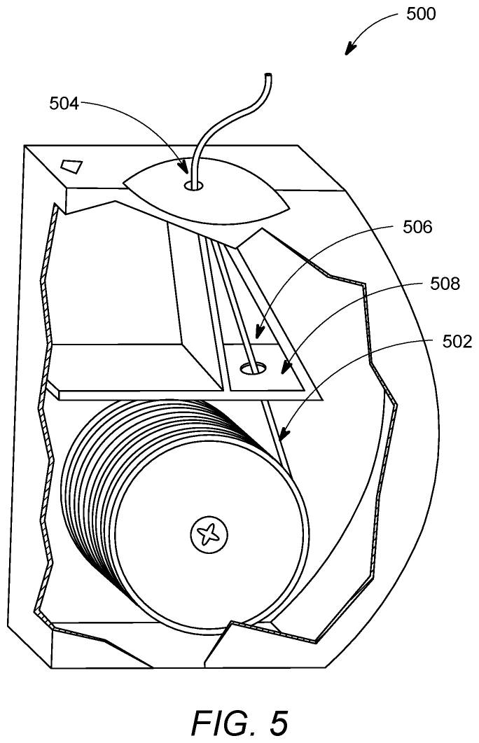

FIG. 5 is view of a fifth aspect of a dental hygiene device 500 according to the disclosure. The dental hygiene device 500 includes design details and/or floss directing implements(s) applied to or modifying the basic device configuration 100 that solve the

problem of maintaining adhesion between the pool of dentifrice as the dental floss 502 is drawn through it to coat the floss. This serves performs two functions: First, it prevents the erosion of a rut that separates the dentifrice from the dental floss 502 and prevents its adhesion to the dental floss 502, which is required to coat the dental floss 502. Second, maintaining this adhesion of dentifrice to the dental floss 502 allows the dental floss 502 to
draw the dentifrice toward the exit aperture 504 as the dentifrice is depleted in the dentifrice chamber 506, thus ensuring it remains near the dental floss 502 so that it can be consumed during usage. This works in conjunction with an exit aperture 504 that is designed to restrict the coating of dentifrice on the dental floss 502 as it exits the dental hygiene device 500, thus allowing dentifrice to accumulate inside of the exit aperture 504.

There are two primary causes for breaking the needed adhesion as the floss as it is drawn through the dentifrice, which causes the erosion of a rut: too great of an opposing adhesion of the dentifrice to the surrounding surfaces, and a column of dentifrice that is too large, creating too much resistance for the surface adhesion to overcome.

The dental hygiene device 500 illustrated in FIG. 5 solves the floss adherence

problem by narrowing the second, dentifrice chamber 506, in conjunction with lining an inside surface 508 of the dentifrice chamber 506 with a non-stick material, reducing both the amount of dentifrice that must be drawn while reducing adhesion with the chamber walls. By keeping the dentifrice in the dentifrice chamber 506 within close proximity to the dental floss 502, its affinity to attach to the dental floss 502 remains greater than the inside surface 508 of
the dentifrice chamber 506. This is suitable for a configuration that will be frequently refilled, such as the variant that is attached to a toothpaste tube, since the limited the quantity of dentifrice creates the need to frequently refill the dentifrice chamber 506.

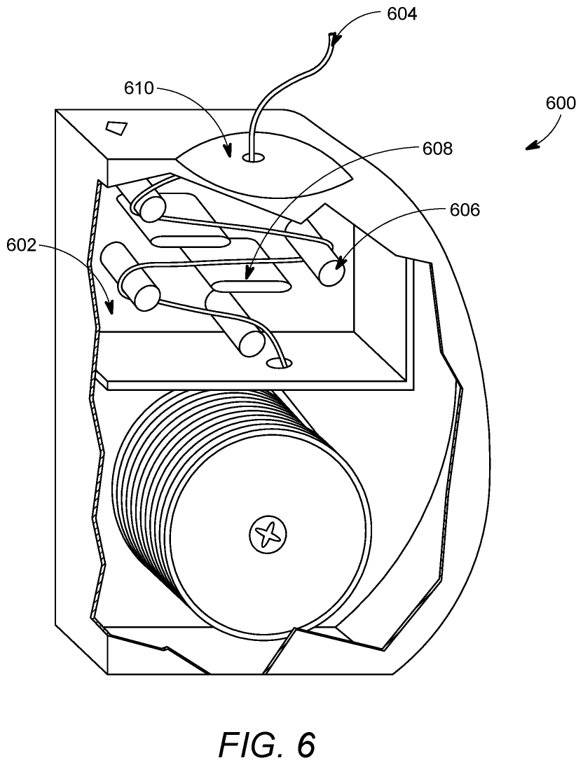

FIG. 6 is a view of a sixth aspect of a dental hygiene device 600 according to the disclosure. The dental hygiene device 600 illustrated in FIG. 6 solves the floss adherence problem by directing the dental floss 604 to move across the chamber 602 around floss directing elements, such as pegs 606 and optionally adding other floss directing elements,

such as baffles 608 between them to enhance the ability for the dentifrice chamber 602 to accumulate along those pathways. This allows for a larger dentifrice chamber 602, and thus a reduced rate of refilling the dentifrice chamber 602. The dental hygiene device 600 may include an indentation 610 which may improve usage while the dental hygiene device 600 is being held in hand while flossing. Other floss directing elements, such as bladders or other
elements may be used as well.

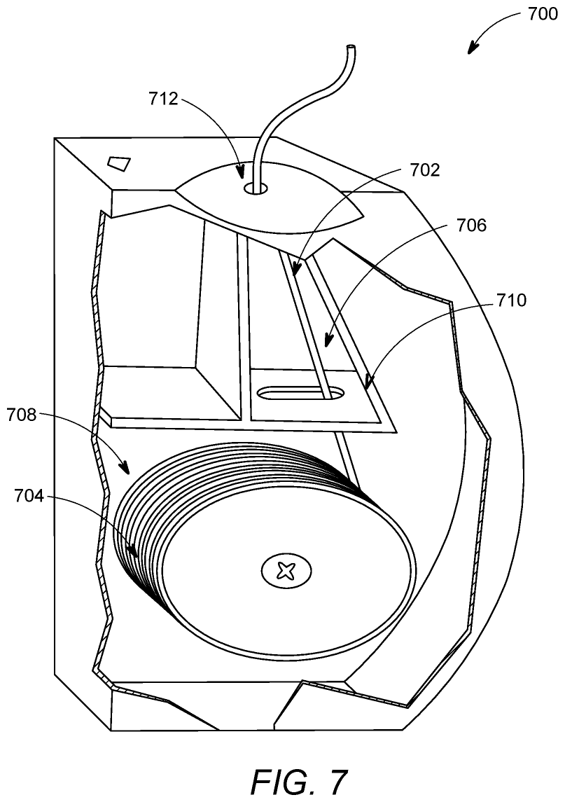

FIG. 7 is a view of a seventh aspect of a dental hygiene device 700 according to the disclosure. The dental hygiene device 700 illustrated in FIG. 7 solves the floss adherence problem by configuring the dental hygiene device 700 so that as the dental floss 702 is drawn from the spool 704, it produces lateral movement to the dental floss 702,

causing the dental floss 702 to sweep across the dentifrice chamber 706, thus maintaining contact between the dental floss 702 and toothpaste dentifrice solution and preventing ruts. It was surprising to find that moving the dental floss 702 through the toothpaste dentifrice solution in this manner has a similar effect as narrowing the dentifrice column, causing the toothpaste dentifrice solution to adhere to the dental floss 702 and produce the desired results
of drawing the dentifrice toward the exit aperture 712 even with a wider column of toothpaste dentifrice solution. The primary advantage is that this allows for a larger dentifrice chamber, reducing the frequency of refilling the chamber. Producing this needed lateral movement can be accomplished with the dental hygiene device 700, where the dental floss 702 may be drawn from an asymmetric, eccentric spool 704, creating a lateral movement of the departure
point when the asymmetric, eccentric spool 704 rotates as the eccentric spool 704 is retracted. The dentifrice chamber 706 can be modified so that the side walls 710 run parallel to where the floss path is farthest from the centerline. This lateral floss movement keeps the dental floss 702 in contact with toothpaste dentifrice solution and acts to draw and pool the dentifrice closer to the exit aperture 712 which dams any toothpaste dentifrice solution in
excess of what is consumed by coating the dental floss 702 as it exits the dentifrice chamber 706. As toothpaste dentifrice solution is depleted in the dentifrice chamber 706, the
remaining toothpaste dentifrice solution migrates toward the narrowing chamber in front of the exit aperture 712, maintaining a continual pool for adherence.

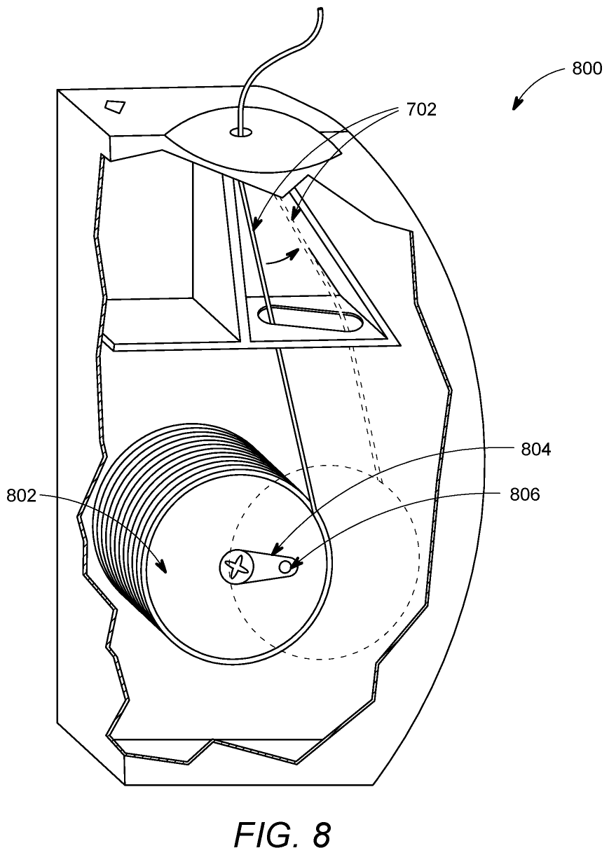

FIG. 8 is a view of an eighth aspect of a dental hygiene device 800 according to the disclosure. The dental hygiene device 800 illustrated in FIG. 8 solves the floss

adherence problem by mounting a circular spool 802 on an arm 804 centered on a pivot pin 806 to offset the circular spool 802, or a cam, for example, causing this same asymmetry and resulting in a similar lateral movement of the dental floss 702 as circular spool 802 rotates. This requires more space and therefore a larger device, because of the larger pathway that the circular spool 802 covers.

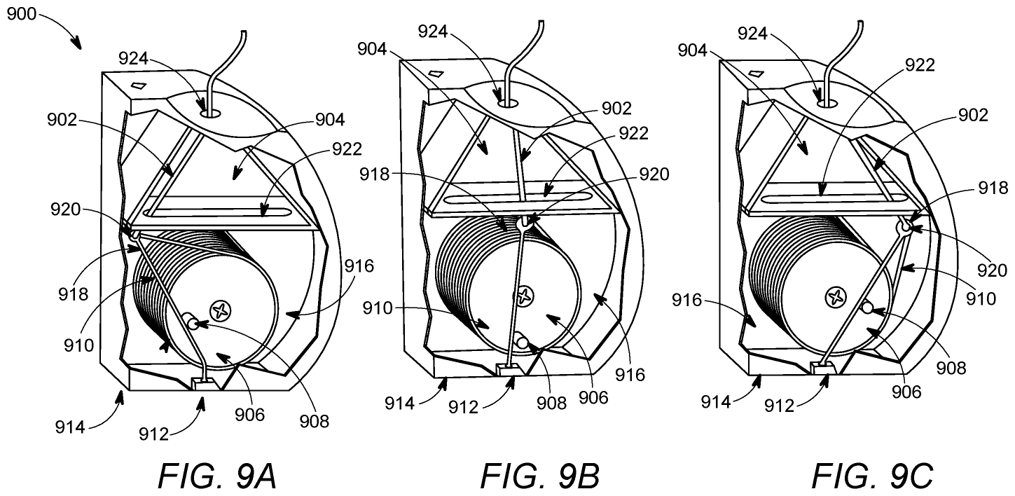

FIGS. 9a-9c are views of ninth aspect of a dental hygiene device 900 according to the disclosure. The dental hygiene device 900 illustrated in FIGS. 9a-9c solves the floss adherence problem by providing a mechanism that creates the lateral floss movement described in relation to FIGS. 7 and 8, causing the end of the dental floss 902 to move back and forth from one side of the second, dentifrice chamber 904 to the other side of the

dentifrice chamber 904 as dental floss 902 is drawn from the spool 906. FIGS. 9a-9c illustrate this mechanism. A peg 908 is affixed to the spool 906 so that the peg 908 rotates with the spool 906 as the dental floss 902 is drawn from the spool 906. A guide wire 910, such as a spring steel wire or other rigid member, adjacent to the spool 906 has a first end 912 movably and pivotably affixed to a base 914 of the first, floss chamber 916. A second end 918 of the
guide wire 910 moves freely and has a hole 920 that the floss is threaded through as it leaves the spool 906 and exits the floss chamber 916. The guide wire 910 is tensioned so that, in position 1 illustrated in FIG. 9a, the guide wire 910 is pressed toward the left side of the floss chamber 916 by spring action but prevented from moving further to the right by the peg 908. As the spool 906 rotates, the peg 908 moves with it (illustrated in FIG. 9b), straightening the
guide wire 910 and then pressing the guide wire 910 toward an opposite side of the floss chamber 916 (illustrated in FIG. 9c). The resulting lateral displacement at second, free end 918 of the guide wire 910 causes the hole 920 at that second end 918 to move across the floss chamber 916, thus guiding the dental floss 902 to swing from the left side to the right side as dental floss 902 is drawn from the spool 906 and exits the floss chamber 916 (via the slotted
opening 922). This lateral displacement as the dental floss 902 exits the floss chamber 916 changes the pathway by which the dental floss 902 travels through the dentifrice chamber 904 toward the fixed aperture 924 where it exits the dental hygiene device 900, as depicted in
FIGS. 9a-9c. The advantage of this approach is that it produces far more lateral floss movement, allowing the floss 902 to remain in contact with the dentifrice and preventing rutting across a far greater dentifrice chamber 904 size. This is most suitable to a handheld version, particularly the mechanism to amplify lateral floss movement because it supports a
compact design and may permit sufficient dentifrice volume to not require replenishment before the floss spool 906 is consumed.

FIGS. 9a-9c provide a view of three positions of the spool 906 and peg 908. FIG. 9a depicts the guide wire 910 in its far-left position, with the guide wire 910 held from springing further to the right by the peg 908. The hole 920 in its second end 918 holds the

dental floss 902 to enter on the far-left side of the dentifrice chamber 904 through a slotted opening 922 between the chambers. The second position, illustrated in FIG. 9b is with the spool 906 rotated 90 degrees, translating the peg 908 to the bottom of the spool 906. This allows the spring wire to translate to the center of the spool 906, with the hole 920 at the tip causing the dental floss 902 to enter the dentifrice chamber 904 at its center. The third
position, illustrated in FIG. 9c shows the spool 906 rotated 180 degrees, translating the peg 908 to the far-right side along with the guide wire 910, causing the dental floss 902 to enter the dentifrice chamber 904 on the far-right side through the slotted opening 922. This mechanism allows for the dental floss 902 to sweep across a much larger dentifrice chamber 904, better utilizing the available space within the dental hygiene device 900. Not shown are
the subsequent positions, where the spool 906 rotates forward causing the peg 908 and thus the guide wire 910 to begin moving back to the left again.

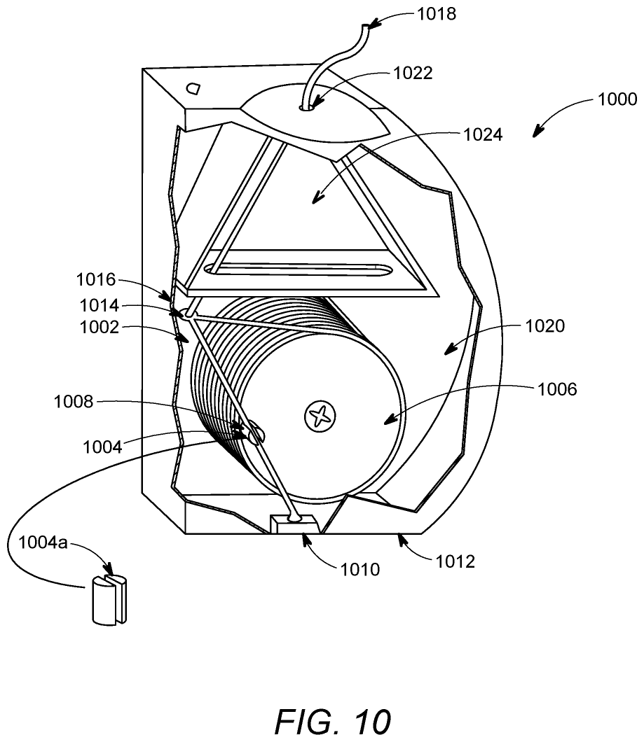

FIG. 10 illustrates a tenth view of a dental hygiene device 1000. The dental hygiene device 1000 operates in a similar manner as the dental hygiene device 900 illustrated in FIGS. 9a-9c. The dental hygiene device 1000 includes a solid, non-flexible rod 1002

instead of the guide wire 910 in FIGS. 9a-9c. FIG. 10 illustrates that the peg 1004 is now slotted and is free to rotate within the spool 1006, as shown in the blown-up view 1004a. The rod 1002 is inserted into the slot 1008 within the peg 1004 and is free to slide back and forth through the slot 1008. A first end 1010 of the rod 1002 is pivotably hinged at the base 1012 of the dental hygiene device 1000 so that its angle can change as the peg 1004 changes
position when the spool 1006 rotates. A second, free end 1014 of the rod 1002 is unrestrained and contains a hole 1016 through which the dental floss 1018 must pass as it leaves the spool 1006 and exits the floss chamber 1020. As the spool 1006 rotates, the peg 1004 moves with
it, causing the rod 1002 captured by its slot 1008 to move with it as well just as the guide wire 910 in FIGS. 9a-9c moved from position 1 to position 3 in FIGS. 9a-9c. The resulting lateral displacement at end of the rod 1002 causes the hole 1016 to move across the floss chamber 1020, thus guiding the dental floss 1018 exiting the floss chamber 1020 to swing
from the left side to the right side as dental floss 1018 is drawn from the spool 1006. This lateral displacement changes the pathway by which the dental floss 1018 travels through the dentifrice chamber 1024 toward a fixed exit aperture 1022.

While various embodiments of the invention have been described, it will be apparent to those of ordinary skill in the art that many more embodiments and

implementations are possible within the scope of the invention. Accordingly, the invention is not to be restricted except in light of the attached claims and their equivalents.

What is claimed is:

1. A dental hygiene device for cleaning surfaces between adjacent teeth, the dental hygiene device comprising:
a housing configured to be held by a hand during flossing;
the housing comprising a chamber within the housing;
a toothpaste dentifrice solution contained within the chamber; and
dental floss disposed within the housing on a spool, the dental floss and the spool configured to thread through the chamber, where the chamber comprises one or more apertures configured to allow the dental floss to receive a thin coat of the toothpaste dentifrice solution while passing through the chamber, where the chamber comprises a floss directing implement to improve adhesion of the toothpaste dentifrice solution onto a surface of the dental floss as it passes through the chamber, the dental floss further configured to exit the chamber through an inner exit aperture of the one or more apertures in the housing, sufficient to permit the dental floss to pass through with the thin coat of the toothpaste dentifrice solution on the surface of the dental floss, the inner exit aperture configured to extend out of the housing through an outer exit aperture, where a diameter of the inner exit aperture has a sufficiently greater diameter than a diameter of the dental floss to regulate an amount of the toothpaste dentifrice solution that passes through the outer exit aperture on the dental floss to allow a continuous distribution of abrasive ingredients to coat the dental floss, but no larger than is needed to allow enough of the toothpaste dentifrice solution to pass through to produce a needed coating on the dental floss, and where a housing size and a housing shape are specifically configured to permit the dental hygiene device to be comfortably held while also drawing the dental floss coated with the toothpaste dentifrice solution containing a continuous distribution of abrasive particles with a sufficient surface to not interfere with flossing.

2. The dental hygiene device of claim 1, where the toothpaste dentifrice solution comprises a semi-solid material with mild abrasive qualities and a viscosity and a thickness of toothpaste.

3. The dental hygiene device of claim 1, further comprising an exit aperture with a diameter of between larger than the diameter of the dental floss to of 1.5 times the diameter of the dental floss to regulate the amount of toothpaste dentifrice solution that passes through the exit aperture on the dental floss.

4. The dental hygiene device of claim 1, further comprising a dental tape with an exit aperture with a slotted shape sized with sufficiently greater dimensions than a thickness of the dental tape to regulate the amount of toothpaste dentifrice solution that passes through the exit aperture on the dental tape.

5. The dental hygiene device of claim 1, where the housing may be opened revealing the chamber and making it accessible to be filled with the toothpaste dentifrice solution to receive the toothpaste dentifrice solution prior to use of the dental hygiene device.

6. A dental hygiene device for cleaning between surfaces of teeth, the device comprising:
a dispensing device configured to be held by a hand during flossing;
a first chamber containing dental floss positioned around a spool, the first chamber positioned within the dispensing device, where the first chamber comprises a first outlet opening through which the dental floss exits the first chamber;
a second chamber containing a toothpaste dentifrice solution, the second chamber positioned proximate to the first chamber, where the second chamber is positioned within the dispensing device, and the second chamber comprises:
an inlet opening positioned on a first surface of the second chamber and proximate to and in mechanical communication with the outlet hole of the first chamber,
where the dental floss that exits the first chamber enters the inlet opening of the second chamber,
where the second chamber is configured to allow the dental floss to receive a thin coat of the toothpaste dentifrice solution on a surface of the dental floss while passing through the first chamber; and
a second outlet hole positioned on a second surface of the second chamber, where the dental floss exits the second outlet hole and out of the dispensing device, where a diameter of the second outlet hole is sized with a sufficiently greater diameter than a diameter of the dental floss to regulate the amount of toothpaste dentifrice solution that passes through the second outlet opening on the dental floss to allow a continuous distribution of abrasive ingredients to coat the dental floss, but no larger than is needed to allow a dentifrice thickness to pass through that leaves a sufficiently thin film to not interfere with flossing; and where a dispensing housing size and a dispensing housing shape are configured to permit the dispensing device to be comfortably held while also drawing the dental floss coated with the toothpaste dentifrice solution from the dispensing device while flossing.

7. The dental hygiene device of claim 6, where the dispensing device further comprises a tab positioned on a surface of the dispensing device, where the tab is angled outwardly relative to the surface of the dispensing device, and the tab comprises a clipper edge configured to accept the dental floss and sever the dental floss.

8. The dental hygiene device of claim 6, where the toothpaste dentifrice solution comprises a semi-solid material with mild abrasive qualities and a viscosity and a thickness of toothpaste.

9. The dental hygiene device of claim 6, where the dispensing device further comprises an opening to reveal an inside of the dispensing device for filling the second chamber containing the dentifrice solution and replacing the spool; and where the opening may be configured as a moveably sealable aperture to fill the second chamber while preventing leakage through the housing during use.

10. The dental hygiene device of claim 6, further comprising floss directing implements to direct a floss path through the first chamber and the second chamber and/or promoting accumulation of the toothpaste dentifrice solution in a proximity of the dental floss to improve adhesion of the toothpaste dentifrice solution onto the surface of the dental floss as it passes through the second chamber.

11. The dental hygiene device of claim 6, further comprising a non-stick material deposited on an inner surface of the second chamber to improve adhesion of the toothpaste dentifrice solution onto the surface of the dental floss as it passes through the second chamber.

12. The dental hygiene device of claim 6, further comprising a chamber insert positioned within the second chamber to maintain the toothpaste dentifrice solution in proximity with the dental floss as the toothpaste dentifrice solution is consumed during use and to improve adhesion of the toothpaste dentifrice solution onto the surface of the dental floss as it passes through the dentifrice.

13. The dental hygiene device of claim 12 where the chamber insert comprises at least one of a membrane, a bladder or a combination thereof.

14. The dental hygiene device of claim 6, where the spool comprises an asymmetric cam, the asymmetric cam causing a lateral change in positioning of a point that the dental floss leaves the floss chamber with respect to a center of the first chamber as the dental floss is drawn from the spool, changing an angle and a path that the dental floss exits the first chamber and progresses through the inlet opening into the second chamber and through the second chamber to the second outlet hole, causing the dental floss to move laterally across the second chamber as it is drawn from the spool, causing improved contact with the toothpaste dentifrice solution as the dental floss is drawn through the dentifrice chamber.

15. The dental hygiene device of claim 6, further comprising a floss guiding device positioned within the first chamber and causing a location that the dental floss exits the first chamber to move back and forth from a first side of the first chamber to a second side of the floss chamber with respect to a center of the first chamber as the dental floss is drawn from the spool, changing an angle and a path that the dental floss exits the first chamber and progresses through the inlet opening into the second chamber and through the second chamber to the second outlet hole, causing the dental floss to sweep across the second chamber as it is drawn from the spool, causing improved contact with the toothpaste dentifrice solution as the dental floss is drawn through the second chamber.

16. The dental hygiene device of claim 6, further comprising a dispenser adaptor adaptively coupled to the dispensing device.

17. The dental hygiene device of claim 16, where the dispenser adaptor is adaptively coupled to receive a toothpaste tube.

18. The dental hygiene device of claim 16, where the dispenser adaptor comprises a nozzle for providing toothpaste into the dispensing device.

19. The dental hygiene device of claim 16, where the dispenser adaptor comprises a second nozzle and cap for dispensing toothpaste from the dispensing device.

20. The dental hygiene device of claim 16, where the dispenser housing is configured to attach to the nozzle of a toothpaste tube and function both for dispensing toothpaste onto a toothbrush from the dispensing device and dispensing dental floss coated with toothpaste dentifrice solution.
